(19) United States
(12) Patent Application Publication
(10) Pub. No.: US 2022/0279107 A1
(43) Pub. Date: Sep. 1, 2022

(54) DIGITAL NIGHT VISION DEVICE WITH ADJUSTABLE IMAGE ACQUISITION SPEED

(71) Applicant: PHOTONIS FRANCE, Brive (FR)

(72) Inventor: Geoffroy DELTEL, Brive (FR)

(21) Appl. No.: 17/625,519

(22) PCT Filed: Jul. 9, 2020
(86) PCT No.: PCT/FR2020/051230

§ 371 Date: Jan. 7, 2022

(30) Foreign Application Priority Data
Jul. 10, 2019 (FR) FR1907714

(51) Int. Cl. H04N 5/235; H04N 5/225

(52) U.S. Cl. CPC H04N 5/2351; H04N 5/2258; G01P 3/00

(57) ABSTRACT

Night vision device including at least one sensor array, a display screen for displaying an image obtained using the sensor array, a speed measuring device mounted integral with the sensor array and the display screen, and a control device. The control device is configured to receive as input a speed measurement provided by the speed measuring device, and to control in response a frequency of image acquisition by the sensor array so that the frequency of image acquisition increases when the speed measurement increases. Thus, the night vision device prevents any sick feeling for the user when their head is moving, while using a conventional sensor array and limiting an average electric consumption.

### TECHNICAL FIELD

The invention relates to the field of digital night vision devices.

### PRIOR ART

It is known in prior art two large families of night vision devices, intended to be mounted on the head of a user in order to enable him to observe in real time a surrounding scene despite a low lighting of said scene.

A first family of night vision devices groups the analogue devices, based on image intensification technology. This technology uses an image intensifier tube, comprising a photocathode capable of converting an incident photon flux into an initial electron flux. Said initial electron flux propagates to multiplication means. Each electron incident on the multiplication means causes a plurality of secondary electrons to be emitted. Thus, an intense electron flux is generated. The intense electron flux is received by a phosphorous screen, which converts said intense electron flux into an intense photon flux. Said intense photon flux corresponds to the photon flux incident on the photocathode, but is more intense. A latency, between a variation in the surrounding scene and the translation (or transduction) thereof on the image formed by the night vision device, is in the order of a one millisecond only.

A second family of night vision (or low level light) devices groups the digital devices, based on an image acquisition using a sensor array, and a restitution of the image acquired on a display screen. The sensor array converts an incident optical flux into electrical signals. The electrical signals are subsequently transferred to a display screen, for example of liquid crystal display type, for the display of an image representative of the distribution of the optical flux incident on the sensor array. The sensor array consists of sensors sensitive in the visible spectrum and/or the infrared spectrum, for the acquisition of an image (intensified or not) of a dimly lit scene, or of an infrared image of said scene.

The compatibility of said second technology with a use during movement, and particularly with the carriage thereof on the head of a user, is limited by a feeling of nausea that may be felt by the user. Said feeling of nausea is induced, inter alia, by a latency between a variation on the surrounding scene and the translation (or transduction) thereof on the image formed on the display screen. The latency is related to a frequency of image acquisition by the sensor array. Said frequency of acquisition is generally equal to 25 Hz, or approximately 50 Hz, which corresponds to a latency of 40 ms, or approximately 20 ms. Said high latency causes a sick feeling for the user when its head moves relatively with the surrounding scene, and in particular when he turns its head.

One aim of the present invention is to propose a digital night vision device, making it possible to prevent any sick feeling for the user when its head moves relatively to the surrounding scene, and in particular when he turns its head.

### DESCRIPTION OF THE INVENTION

Said aim is achieved with a night vision device intended to be mounted on the head of a user, and comprising:
at least one sensor array; and
a display screen configured to display an image obtained using the sensor array.

According to the invention, the night vision device further comprises:
a speed measuring device, mounted integral with an assembly comprising at least the sensor array and the display screen; and
a control device, configured to receive as input at least one speed measurement provided by the speed measuring device, and to control in response a frequency of image acquisition by the sensor array, so that the frequency of image acquisition increases when said speed measurement increases.

In the context of a digital night vision device, it is understood that the sensor array comprises sensors that are highly sensitive in the visible spectrum and/or sensors sensitive in the infrared spectrum, for the acquisition of an image of a dimly lit scene and/or of an infrared image of said scene. The infrared spectrum more specifically designates a range of wavelengths ranging from 700 nm to 0.1 mm.

One obvious solution, in order to prevent any sick feeling for the user when their head moves relatively to the surrounding scene, would consist of reducing the latency, regardless of the conditions of use of the night vision device. However, a low latency, and therefore a rapid frequency of acquisition by the sensor array, induces a low integration time for said sensors which is in contradiction with the high sensitivity required in the context of a night vision device.

The idea underlying the invention consists in noting that, when the head of the user is moving relatively to the surrounding scene, the user pays little attention to the details of the image that he sees on the display screen. It is then possible to tolerate a degradation of the quality of said image, in comparison with the periods where the head of the user is immobile or almost relatively to the surrounding scene.

The night vision device according to the invention is therefore configured to adapt the frequency of image acquisition by the sensor array to the speed of the movement of the head of the user relatively to said surrounding scene. When the head of the user is immobile or almost relatively to the surrounding scene, the frequency of image acquisition is slow, which makes it possible to acquire a good quality image of the surrounding scene despite poor lighting conditions (high integration time of the sensors of the sensor array, and therefore good signal-to-noise ratio). When the head of the user is moving relatively to the surrounding scene, the frequency of image acquisition increases, which makes it possible to prevent any sick feeling for the user. Said increase of the frequency of image acquisition results in a loss of quality for the image acquired by the sensor array. However, for the reasons mentioned above, said loss of quality is tolerated since same only occurs when the head of the user is moving relatively to the surrounding scene.

Thus, the invention proposes a digital night vision device, which makes it possible to prevent any sick feeling for the user when its head moves relatively to the surrounding scene, without reducing a perception of quality of the night vision offered by the device.

Optional features of the invention are mentioned in the dependent claims.

The invention also covers a method for adjusting a frequency of image acquisition implemented in a night vision device according to the invention, mounted on the head of a user, the method comprising the steps of:
using the speed measuring device, measuring at least one speed of the assembly comprising at least the sensor array and the display screen;
using the control device, controlling the frequency of image acquisition by the sensor array so that the frequency of image acquisition increases when said speed measurement increases.

### BRIEF DESCRIPTION OF THE FIGURES

The present invention will be better understood upon reading the description of examples of embodiments given, purely by way of indicative and non-limiting example, while referring to the appended drawings wherein:

FIG. 1A schematically illustrates a night vision device according to the invention, mounted on the head of a user;

FIG. 1B schematically illustrates a night vision device according to the invention;

FIG. 2A schematically illustrates a first embodiment of a method implemented in a night vision device according to the invention;

FIG. 2B schematically illustrates a second embodiment of a method implemented in a night vision device according to the invention;

FIG. 2C schematically illustrates a third embodiment of a method implemented in a night vision device according to the invention; and

FIG. 3 schematically illustrates an image acquisition in the night vision device according to the invention, when the head of the user is moving.

### DESCRIPTION OF EMBODIMENTS

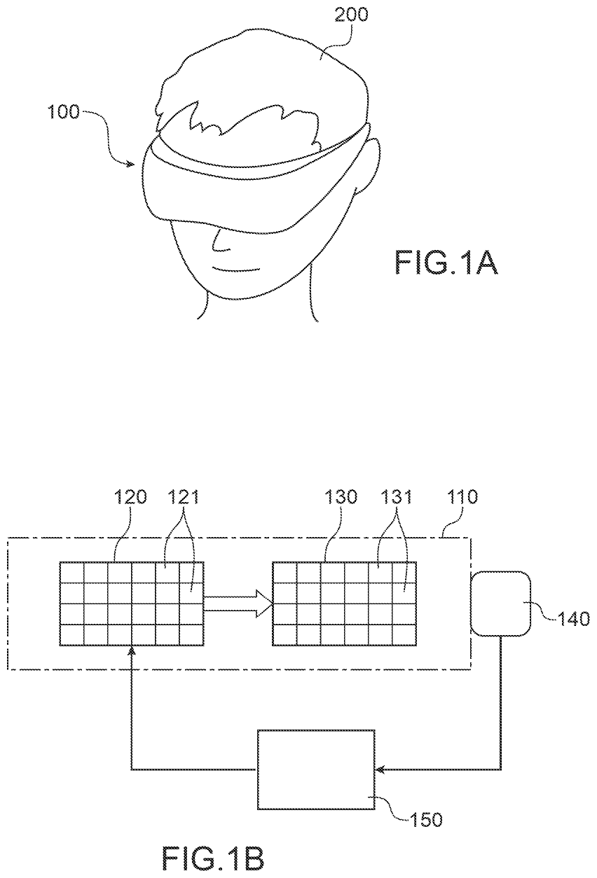

FIG. 1A illustrates, schematically, a night vision device 100 according to the invention mounted on the head of a user 200. The night vision device 100 forms a portable device, capable of being mounted on the head of the user 200 by covering at least one portion of its face at eye level. The night vision device 100 is presented for example in the form of goggles, of a mask or of a helmet integrating the elements of the night vision device. During use, the night vision device 100 is stationary relatively to the head of the user 200.

FIG. 1B schematically illustrates the night vision device 100. The night vision device 100 comprises in particular a transduction module 110 producing the transduction of a distribution of light signal in a surrounding scene into an image capable of being seen by the user.

The transduction module 110 includes here a sensor array 120 and a display screen 130.

The sensor array 120 includes a plurality of sensors 121, distributed according to a regular meshing, for example in a non-limiting way in rows and columns.

The sensors 121 are each capable of converting an incident light flux into an electrical signal.

The sensors 121 may comprise high-sensitivity sensors, sensitive in the visible spectrum (between 400 nm and 700 nm), and/or sensors sensitive in the infrared spectrum, sensitive for example over a spectral band ranging from 700 nm to 1700 nm, or ranging from 700 nm to 1100 nm, or ranging from 700 nm to 900 nm, or ranging from 8 μm to 12 μm.

Each sensor 121 may be formed by:
a CMOS sensor known as LLL, for low level light, capable of detecting very low intensity light rays; or
a sensor known as EB-CMOS, for electron-bombarded CMOS sensor, including a photocathode for converting an incident photon flux into an electron flux and a CMOS sensor capable of converting an incident electron flux into an electrical measurement signal; or
a sensor known as I-CMOS, for intensified CMOS; or
an infrared photodiode; etc.

The sensor array 120 may comprise a plurality of types of sensors, which differ for example by the spectral sensitivity band thereof, and distributed into a plurality of intertwined or even juxtaposed elementary arrays. According to one variant not shown, the night vision device according to the invention comprises a plurality of distinct and juxtaposed sensor arrays, which differ by the type of sensor of which same are composed, where the various types of sensors are distinguished from one another by the spectral sensitivity band thereof. In said two variants, the at least one sensor array is connected to a processing module, configured to receive as input the electrical signals provided by each of the sensors of the at least one sensor array and to form, using said signals, an image known as merged image, grouping data relative to various spectral detection bands.

The display screen 130 is connected to the sensor array 120, and configured to display an image in visible light in response to the reception of electrical signals coming directly or indirectly from the sensor array. The display screen emits in particular at wavelengths ranging from 400 nm to 700 nm.

Preferably, the display screen 130 is configured to display an image in levels of grey. An image in levels of grey is made up of pixels that only differ by the light intensity thereof. In practice, the image known as in levels of grey may appear in green. The display screen 130 is for example a liquid crystal display (LCD).

Here, the display screen 130 is configured to receive as input electrical signals provided directly by the sensor array 120. According to a variant not shown, the display screen 130 is configured to receive as input electrical signals coming indirectly from the at least one sensor array. Said electrical signals are then provided by a processing module, or processor, which transforms first electrical signals, provided as output of the at least one sensor array, into second electrical signals, sent to the screen 130. Said processing module is for example a processing module such as mentioned above, configured to merge data relating to various spectral detection ranges. In particular, the sensor array 120 may include various types of sensors that differ by the respective spectral sensitivity ranges thereof, and the processing module is configured to merge data coming from each type of sensor according to a dedicated algorithm. The merged image thus generated is displayed by the screen 130.

The night vision device 100 thus forms a digital device, based on a digital detection of a dimly lit scene.

Many variants of the transduction module 110 may be implemented without departing from the scope of the invention. For example, the sensor array may comprise sensors of which the spectral sensitivity range extends not only in the infrared spectrum, but also outside of the infrared spectrum. The sensor array may comprise sensors of various types, which differ by the respective spectral sensitivity ranges thereof. Alternatively, all the sensors of the sensor array are sensors of the same type, particularly high-sensitivity sensors sensitive in the visible spectrum or sensors sensitive over a same spectral band belonging to the infrared spectrum. According to other variants, the sensor array also includes sensors sensitive in the visible spectrum (between 400 nm and 700 nm) and/or sensors sensitive in the near ultraviolet spectrum (between 200 nm and 400 nm) and/or sensors sensitive in the ultraviolet spectrum (between 10 nm and 200 nm), with preferably a majority of the sensors of the sensor array that are sensors sensitive in the infrared spectrum or high-sensitivity sensors.

According to the invention, the night vision device 100 further comprises a speed measuring device 140, and a control device 150 for controlling the frequency of image acquisition by the sensor array 120.

The speed measuring device 140 is mounted integral with an assembly including at least the sensor array 120 and the screen 130.

During operation, when the night vision device 100 is positioned on the head of the user, the speed measuring device 140 therefore makes it possible to measure a movement speed of the head of the user relatively to the terrestrial reference frame.

The speed measuring device 140 is configured to measure at least one linear speed and/or at least one rotation speed. Same may comprise at least one linear speed sensor, of accelerometer type, and/or at least one rotation speed sensor, of gyrometer type. Same comprises for example three linear speed sensors, for measuring a linear speed according to each of the three axes of an orthonormal coordinate system, and three rotation speed sensors, for measuring a rotation speed about each of said three axes. When same comprises a plurality of speed sensors, the speed measuring device 140 advantageously includes a processor configured to combine the measurements provided by each of said sensors so as to provide as output a single speed measurement.

The control device 150 preferably comprises a central unit having a processor implementing programs saved in a memory. The control device 150 is configured to:
receive as input a speed measurement provided by the speed measuring device 140;
produce a processing of said speed measurement so as to determine a setpoint value relative to the frequency of image acquisition by the sensor array 120 (respectively by each of the sensor arrays, when there are a plurality thereof as mentioned above); and
set the frequency of image acquisition by the sensor array 120 at said setpoint value (respectively the frequency of image acquisition by each of the sensor arrays, when there are a plurality thereof as mentioned above).

The frequency of image acquisition by the sensor array 120 is a number of images per unit of time that translates (or reflects) the speed at which the sensor array 120 transforms a distribution of light signals in the surrounding scene into a distribution of electrical signals. Said frequency is equal to the reciprocal of the duration that is necessary so that said array acquires a given image of the surrounding scene.

According to the invention, the control device 150 is configured to define said setpoint value so that a high value of the speed measured by the speed sensor corresponds to a high frequency of image acquisition by the sensor array, and vice versa. Thus, when the head of the user is moving, the frequency of image acquisition by the sensor array 120 is increased which prevents any sick feeling for the user.

Preferably, the sensor array 120 is a conventional sensor array in the field of night vision, provided for operating at a nominal frequency of image acquisition lower than 100 Hz, for example 50 Hz or 25 Hz.

When the head of the user is immobile relatively to the surrounding scene, the frequency of image acquisition by the sensor array is equal to said nominal frequency of image acquisition, which makes it possible to acquire images of good quality.

When the head of the user is moving relatively to the surrounding scene, for example when the user turns, raises or lowers its head, the frequency of image acquisition by the sensor array is significantly increased, in order to prevent any sick feeling for the user. The image acquired by the sensor array is then a degraded image. However, said degradation of image occurs at instants at which the user is not attentive to the quality of the image that he sees.

Thus, the invention makes it possible to prevent any sick feeling for the user when its head is moving relatively to the surrounding scene, while using a conventional sensor array having a reasonable cost price. Furthermore, as the frequency of image acquisition by the sensor array is increased only during given clearly defined time intervals, the average energy consumption of the night vision device according to the invention remains limited.

The frequency of image acquisition by the sensor array may reach values ranging up to 1 kHz, corresponding to a latency of the same magnitude as the latency of analogue night vision devices.

At each instant, the frequency of image refresh on the screen 130 is at least equal to the frequency of image acquisition by the sensor array 120. Advantageously, the frequency of image refresh for the image displayed by the screen 130 is decorrelated from the frequency of image acquisition by the sensor array. The screen 130 may then have a constant frequency of image refresh, greater than or equal to the maximum value of the frequency of image acquisition by the sensor array 120. Thus, a visual comfort of the user is improved, while ensuring that the images seen by the user follow one after another at a frequency making it possible to prevent any sick feeling in the event of movement of the head of the user relatively to the surrounding scene.

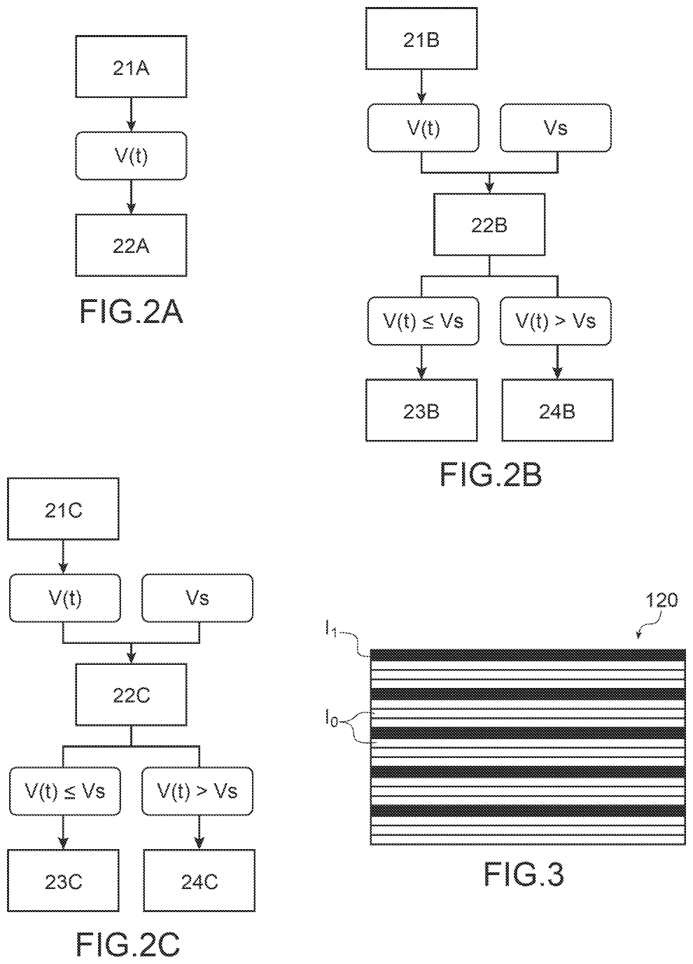

FIG. 2A schematically illustrates a first embodiment of a method implemented in a night vision device as illustrated in FIG. 1B.

In a first Step 21A, the speed measuring device 140 measures a speed V(t) of the assembly comprising at least the sensor array 120 and the display screen 130, and provides said speed measurement V(t) to the control device 150. The speed V(t) may be a combination of a plurality of speeds measured by a plurality of speed sensors of the speed measuring device 140.

In a second Step 22A, the control device 150 uses said speed measurement V(t) to define a setpoint value for the frequency of image acquisition by the sensor array, and sets the frequency of image acquisition par the sensor array 120 at said setpoint value. Said setpoint value may be a linear function of the speed measurement V(t).

FIG. 2B schematically illustrates a second embodiment of a method implemented in a night vision device as illustrated in FIG. 1B.

The first Step 21B corresponds to Step 21A described with reference to FIG. 2A.

In a second Step 22B, the control device 150 compares the speed measurement V(t) with a speed threshold value Vs. Said threshold value Vs is preferably stored in a memory of the control device 150.

When the control device 150 determines that the speed measurement V(t) is lower than or equal to the speed threshold value Vs, it defines a setpoint value corresponding to a first predetermined low value Fb1, and sets the frequency of image acquisition par the sensor array 120 at said setpoint value (Step 23B).

When the control device 150 on the contrary determines that the speed measurement V(t) is greater than the speed threshold value Vs, same defines a setpoint value that depends on the speed measurement V(t), and sets the frequency of image acquisition by the sensor array 120 at said setpoint value (Step 23B). The relation between said setpoint value and the speed measurement V(t) may be linear, but not necessarily.

Thus, it is produced a stabilisation of the frequency of image acquisition, making it possible to disregard slow movements unlikely to create a sick feeling for the user, or too slow to permit a degradation of the image seen by the user.

FIG. 2C schematically illustrates a third embodiment of a method according to the invention that is only described for the differences thereof relatively to the method of FIG. 2B.

Steps 21C to 23C correspond respectively to Steps 21B to 23B described with reference to FIG. 2B.

When the control device 150 determines that the speed measurement V(t) is greater than or equal to the speed threshold value Vs, it defines a setpoint value corresponding to a predetermined high value Fh strictly greater than Fb1, and sets the frequency of image acquisition by the sensor array 120 at said setpoint value (Step 23C).

Said embodiment is particularly simple in that it only includes two modes of operation each associated with a single value of the frequency of image acquisition by the sensor array.

According to one advantageous variant, the control device according to the invention may be configured to determine a current duration of a movement in progress of the head of the user relatively to the surrounding scene. In other terms, this concerns determining in real time the time elapsed from the start of the movement of the head of the user relatively to the surrounding scene. Said duration is determined using measurements provided by the speed measuring device, by considering that the movement starts when the speed measurement is greater than a predetermined speed threshold, and that said movement continues so long as the speed measurement is greater than said predetermined speed threshold.

The control device 150 is configured to compare at each instant said duration with a duration threshold value, and to set the frequency of image acquisition at a second low value Fb2 so long as the current duration of the movement is lower than the duration threshold value. The first threshold value Fb1 and the second threshold value Fb2 may be identical or distinct.

Thus, it is produced a stabilisation making it possible to disregard the movements occurring over a particularly short duration, related for example to a tic of the user.

The increase of the frequency of image acquisition by the sensor array may results in a reduction of an integration time for sensors of said array (duration during which a sensor is exposed to an incident light signal). Each of said sensors then integrates fewer light signals, and therefore provides as output a lower electrical signal. So that the image displayed subsequently by the screen 130 is not too dark, it is therefore advantageous to increase the brightness of the screen in order to compensate said reduction of the integration time. The control device 150 is then configured to further control a brightness of the display by the screen 130. In particular, the control device 150 is configured to increase said brightness at the same time that same increases the frequency of image acquisition by the sensor array, and vice versa. The increase of the brightness of the screen corresponds to an amplification of electrical signals received as input by said screen. The image displayed by the screen 130 remains of lesser quality, particularly in terms of contrast, but same has a brightness offering a good visual comfort, similar to the brightness of the image displayed by the screen in the absence of movement of the head of the user (no feeling of change of brightness for the user).

According to another advantageous variant, the control device 150 may be configured to adjust a number of sensors read on the sensor array. The control device 150 is then configured to reduce said number of sensors read at the same time that same increases the frequency of image acquisition by the sensor array, and vice versa. Thus, it is possible to reduce the electrical consumption related to the acquisition of a given image by the sensor array, and thus to compensate at least partially an increase of the electrical consumption of the night vision device related to the increase of the frequency of acquisition of an image by the sensor array. The reduction of the number of sensors read corresponds to a deterioration of the resolution of the image acquired using the sensor array. However, said deterioration of the resolution occurs at instants where the user is not very sensible to the quality of the image that he sees.

The sensors read are distributed at regular intervals on the sensor array 120. For example, it is read one row of sensors every N rows of sensors, with N an integer greater than or equal to 2. FIG. 3 shows schematically the sensor array 120 of the night vision device according to the invention, with the rows of sensors I₁ read (in black), and the rows of sensors I₀ not read (in white), when the head of the user is moving relatively to the surrounding scene. Alternatively, it is read one sensor per group of M adjacent sensors, with M an integer greater than or equal to 2. It is possible to read alternately the various sensors of the sensor array, so that at each image acquisition, only some of the sensors of the sensor array are read, and so that after J image acquisitions all of the sensors of the sensor array have been read at least once, with J an integer greater than or equal to 2. Throughout the text, the terms “row” and “column” can be inverted.

The sensor array may be a global shutter sensor array, wherein all of the sensors are simultaneously exposed to the surrounding light (integration), then shuttered together for the reading of the respective electrical signals thereof.

Alternatively, the sensor array may be a rolling shutter sensor array, wherein the rows of sensors are exposed one after the other to the surrounding light and the electrical signals of a row of sensors are read at the same time as a next row of sensors is exposed. In this case, the reduction of the number of rows of sensors read on the sensor array automatically results in a reduction of the time for acquiring an image by the sensor array. In other terms, the reduction of the number of rows of sensors read on the sensor array then automatically results in an increase of the frequency of image acquisition by the sensor array. Advantageously, the control device according to the invention is then configured to control the frequency of image acquisition by the sensor array via the control of the number of rows of sensors read on said sensor array (1 row every N rows of sensors, with N an integer greater than or equal to 2). The increase of the frequency of image acquisition by the sensor array is then automatically accompanied by a compensation at least partial of the corresponding increase of the electrical consumption of the night vision device. It is noted that in said embodiment, the increase of the frequency of image acquisition by the sensor array results in a reduction of the resolution of the image acquired, but not in a reduction of the brightness thereof.

In addition or alternatively, the control device 150 may be configured to further adjust a number of pixels activated on the screen 130. The control device 150 is then configured to reduce said number of pixels activated at the same time that same increases the frequency of image acquisition by the sensor array, and vice versa. Thus, it can compensate at least partially the increase of electrical consumption of the night vision device associated with the increase of the frequency of image acquisition by the sensor array. It is possible to activate only the pixels of the screen 130 associated with read sensors of the sensor array. Alternatively, the number of pixels activated on the screen 130 is decorrelated from the number of read sensors on the sensor array.

According to other variants, the night vision device according to the invention includes a luminosity measuring element, configured to acquire a measurement of the ambient luminosity in an external environment of the night vision device. The control device 150 is then configured to receive as input a luminosity measurement acquired using said luminosity measuring element, and to control in response the frequency of image acquisition by the sensor array 120 so that the frequency of image acquisition increases when the value of the ambient luminosity measurement increases. Said control of the frequency of image acquisition depending on the ambient luminosity is preferably implemented in addition to the control of said same frequency depending on the speed measurement provided by the device 140. In particular, the control device 150 may be configured to set a nominal frequency of image acquisition depending on the ambient luminosity, with said nominal frequency of image acquisition that increases when the luminosity increases (and vice versa), and with said nominal frequency of image acquisition that corresponds to the frequency of image acquisition when the head of the user is immobile relatively to the surrounding scene (speed measured zero or lower than a predetermined threshold). Subsequently, the frequency of image acquisition depends on said nominal frequency of image acquisition and on the speed measurement provided by the device 140. In particular, the frequency of image acquisition effectively implemented increases relatively to said nominal frequency of image acquisition, when the speed measurement provided by the device 140 increases. The luminosity measuring element may be formed by an additional sensor, such as a photodiode sensitive in the visible spectrum, or by one portion at least of the sensor array 120. In said variants also, the control device may be configured to further control a brightness of the display by the display screen, and/or a number of sensors read on the sensor array 120, and/or a number of pixels activated on the display screen, depending on the frequency of image acquisition, which then depends on a nominal frequency of image acquisition that depends on the ambient luminosity.

The invention also covers a method for adjusting a frequency of image acquisition implemented in a night vision device according to the invention, and that comprises the steps of:
using the speed measuring device, measuring a speed of the assembly comprising at least the sensor array and the display screen;
using the control device, controlling the frequency of image acquisition by the sensor array, so that the frequency of image acquisition increases when said speed measurement increases.

The step of controlling said frequency of image acquisition may produce an adjustment of the frequency of image acquisition to a value that depends (linearly or not) on the speed measurement provided by the speed measuring device.

The method according to the invention may comprise a step of comparing between the speed measurement provided by the speed measuring device and a speed threshold value, and the step of controlling said frequency of image acquisition may produce an adjustment of the frequency of image acquisition to a first predetermined low value when said speed measurement is lower than the speed threshold value.

If applicable, the step of controlling said frequency of image acquisition may produce an adjustment of the frequency of image acquisition to a predetermined high value, strictly higher than the first predetermined low value, when said speed measurement is greater than the speed threshold value.

Alternatively, the step of controlling said frequency of image acquisition may produce an adjustment of the frequency of image acquisition to a value that depends (linearly or not) on the speed measurement provided by the speed measuring device, when said speed measurement is greater than the speed threshold value.

The method according to the invention may include a step of determining a current duration of a movement in progress, from speed measurements provided by the speed measuring device, a step of comparing said current duration with a duration threshold value, with the step of controlling said frequency of image acquisition that sets the frequency of image acquisition at a second predetermined low value so long as said current duration is lower than the duration threshold value.

The method according to the invention may implement a refresh of the images displayed on the display screen, with the frequency of image refresh for the image displayed on the display screen being decorrelated from the frequency of image acquisition by the sensor array. Said frequency of image refresh may also be equal to a maximum value of the frequency of image acquisition by the sensor array.

The method according to the invention may comprise a step of controlling a brightness of the display by the display screen depending on the frequency of image acquisition, with the brightness that increases with the frequency of image acquisition.

The method according to the invention may comprise a step of controlling a number of sensors read on the sensor array depending on the frequency of image acquisition, with the number of sensors read that decreases when the frequency of image acquisition increases.

If applicable, the sensor array is configured to implement a reading of the sensors row by row, and the step of controlling the frequency of image acquisition by the sensor array is implemented by means of the control of a number of rows of sensors read on the sensor array.

The method according to the invention may comprise a step of controlling a number of pixels activated on the display screen depending on the frequency of image acquisition, with the number of pixels activated that decreases when the frequency of image acquisition increases.

What is claimed is:

1. Night vision device intended to be mounted on the head of a user (100), and comprising:
at least one sensor array;
a display screen, configured to display an image obtained using the sensor array;
a speed measuring device, mounted integral with an assembly comprising at least the sensor array and the display screen; and
a control device, configured to receive as input at least one speed measurement (V(t)) provided by the speed measuring device, and to control in response a frequency of image acquisition by the sensor array so that the frequency of image acquisition increases when said speed measurement increases.

2. Night vision device according to claim 1, wherein the speed measuring device comprises at least one rotation speed sensor.

3. Night vision device according to claim 1, wherein the control device is configured to set the frequency of image acquisition at a value that depends on the speed measurement (V(t)) provided by the speed measuring device.

4. Night vision device according to claim 1, wherein the control device is configured to compare the speed measurement (V(t)) provided by the speed measuring device with a speed threshold value (Vs), and to set the frequency of image acquisition at a first predetermined low value when said speed measurement is lower than the speed threshold value.

5. Night vision device according to claim 4, wherein the control device is configured to set the frequency of image acquisition at a predetermined high value, strictly higher than the first predetermined low value, when said speed measurement (V(t)) is greater than the speed threshold value (Vs).

6. Night vision device according to claim 4, wherein the control device is configured to set the frequency of image acquisition at a value that depends on the speed measurement (V(t)) provided by the speed measuring device, when said speed measurement (V(t)) is greater than the speed threshold value (Vs).

7. Night vision device according to claim 1, wherein the control device is configured to determine a current duration of a movement in progress, from speed measurements provided by the speed measuring device, to compare said current duration with a duration threshold value, and to set the frequency of image acquisition at a second predetermined low value so long as said current duration is lower than the duration threshold value.

8. Night vision device according to claim 1, wherein a frequency of image refresh of the image displayed on the display screen is decorrelated from the frequency of image acquisition by the sensor array.

9. Night vision device according to claim 8, wherein said frequency of image refresh is equal to a maximum value of the frequency of image acquisition by the sensor array.

10. Night vision device according to claim 1, wherein the control device is further configured to control a brightness of the display by the display screen depending on the frequency of image acquisition, with the brightness that increases with the frequency of image acquisition.

11. Night vision device according to claim 1, wherein the control device is configured to control a number of sensors read on the sensor array depending on the frequency of image acquisition, with the number of sensors read that decreases when the frequency of image acquisition increases.

12. Night vision device according to claim 11, wherein the sensor array is configured to implement a reading of the sensors row by row, and in that the control device is configured to control the frequency of image acquisition by the sensor array by means of the control of a number of rows of sensors read on the sensor array.

13. Night vision device according to claim 1, wherein the control device is configured to control a number of pixels activated on the display screen depending on the frequency of image acquisition, with the number of pixels activated that decreases when the frequency of image acquisition increases.

14. Night vision device according to claim 1, further comprising a luminosity measuring element configured to acquire an ambient luminosity measurement, wherein the control device is configured to receive as input said ambient luminosity measurement and to control in response said frequency of image acquisition by the sensor array so that the frequency of image acquisition increases when the value of said ambient luminosity measurement increases.

15. Method for adjusting a frequency of image acquisition, implemented in a night vision device according to claim 1 mounted on the head of a user), the method comprising:
using the speed measuring device, measuring at least one speed (V(t)) of the assembly comprising at least the sensor array and the display screen; and
using the control device, controlling the frequency of image acquisition by the sensor array so that the frequency of image acquisition increases when said speed measurement (V(t)) increases.
